(19) United States
(12) Patent Application Publication
(10) Pub. No.: US 2025/0140923 A1
(43) Pub. Date: May 1, 2025

(54) BATTERY ELECTROLYTE SOLUTION AND BATTERY

(71) Applicant: ZHUHAI COSMX BATTERY CO., LTD., Zhuhai (CN)

(72) Inventor: Yingdi MU, Zhuhai (CN)

(73) Assignee: ZHUHAI COSMX BATTERY CO., LTD., Zhuhai (CN)

(21) Appl. No.: 19/006,933

(22) Filed: Dec. 31, 2024

Related U.S. Application Data
(63) Continuation-in-part of application No. PCT/CN2023/104913, filed on Jun. 30, 2023.

(30) Foreign Application Priority Data
Aug. 25, 2022 (CN) 202211025249.9

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0037

(57) ABSTRACT

Disclosed are a battery electrolyte solution and a battery. The battery electrolyte solution includes an organic solvent, an additive, and an electrolyte salt, the organic solvent includes an ethyl group solvent, and the additive includes 1,3-propane sultone and a nitrile substance. The electrolyte solution is in contact with a positive electrode plate. Percentages of the ethyl group solvent, the 1,3-propane sultone, and the nitrile substance in a total mass of the electrolyte solution are configured as follows: 0.45−N3≤A+B2+C2≤516−N3. N denotes a peeling strength value of the positive electrode plate, in a unit of gf/mm, A, B, and C denotes a percentage of the mass of the ethyl group solvent, 1,3-propane sultone, and the nitrile substance in the total mass of the electrolyte solution.

### CROSS-REFERENCE TO RELATED APPLICATIONS

The present disclosure is a continuation-in-part of International Application No. PCT/CN2023/104913, filed on Jun. 30, 2023, which claims priority to Chinese Patent Application No. 202211025249.9, filed on Aug. 25, 2022. All of the aforementioned patent applications are hereby incorporated by reference in their entireties.

### TECHNICAL FIELD

Embodiments of the present disclosure relate to the field of lithium-ion battery technologies, and in particular, to a battery electrolyte solution and a battery.

### BACKGROUND

A structure of a positive electrode active material in a lithium-ion battery is unstable at a high temperature, and metal ions are easily dissolved and deposited on a surface of a negative electrode plate. This destroys a structure of a solid electrolyte interface (Solid Electrolyte Interface, SEI) film on the surface of the negative electrode plate, which causes a continuous increase in a negative electrode impedance, and further causes a continuous increase in a temperature of the battery, and causes a safety accident when heat accumulates and cannot be released.

Currently, a flame retardant is generally added to an electrolyte solution to improve safety performance of a battery at a high temperature, but adding the flame retardant may lead to degradation of other performance of the battery than safety performance. Therefore, how to improve safety performance of a battery while avoiding degradation of other performance of the battery has become an urgent problem to be resolved.

### SUMMARY

Embodiments of the present disclosure provide a battery electrolyte solution, a preparation method of the battery electrolyte solution, and a battery, which resolves a problem of how to improve safety performance of a battery while avoiding degradation of other performance of the battery.

To achieve the foregoing purpose, according to a first aspect, an embodiment of the present disclosure provides a battery electrolyte solution. The battery electrolyte solution includes an organic solvent, an additive, and an electrolyte salt. The organic solvent includes an ethyl group solvent, and the additive includes 1,3-propane sultone and a nitrile substance. The electrolyte solution is in contact with a positive electrode plate. Percentages of the ethyl group solvent, the 1,3-propane sultone, and the nitrile substance in a total mass of the electrolyte solution are configured as follows:

$$0.45 - {N}^{3} \leq A + {B}^{2} + {C}^{2} \leq 516 - {N}^{3} ,$$

where N denotes a peeling strength value of the positive electrode plate, in a unit of gf/mm, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution.

Optionally, the peeling strength value N of the positive electrode plate ranges from 0.2 gf/mm to 8 gf/mm.

Optionally, the mass of the ethyl group solvent accounts for 40 wt % to 85 wt % of the total mass of the electrolyte solution.

Optionally, the ethyl group solvent includes at least one of ethyl methyl carbonate, diethyl carbonate, methyl propyl carbonate, ethyl propionate, propyl propionate, ethyl acetate, or ethyl butyrate.

Optionally, the ethyl group solvent includes at least one of ethyl methyl carbonate, diethyl carbonate, methyl propyl carbonate, ethyl propionate, or propyl propionate.

Optionally, the mass of the 1,3-propane sultone accounts for 0.5 wt % to 8 wt % of the total mass of the electrolyte solution.

Optionally, the mass of the nitrile substance accounts for 2 wt % to 8 wt % of the total mass of the electrolyte solution.

Optionally, the nitrile substance includes at least one of following: succinonitrile, glutaronitrile, adiponitrile, pimelonitrile, suberonitrile, glycerol trinitrile, ethoxy(pentafluoro)phosphazene, or 1,3,6-hexanetricarbonitrile.

Optionally, the additive further includes a thiophene compound, and a structural formula of the thiophene compound is as follows:

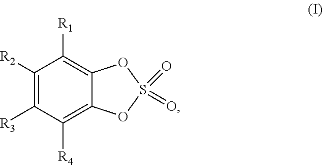

where R₁ is any one of hydrogen, halogen, and an alkyl carbon chain, R₂ is any one of hydrogen, halogen, and an alkyl carbon chain, R₃ is any one of hydrogen, halogen, and an alkyl carbon chain, R₄ is any one of hydrogen, halogen, and an alkyl carbon chain, and a quantity of carbon atoms in the alkyl carbon chain ranges from 1 to 10.

Optionally, the halogen is any one of fluorine, chlorine, and bromine.

Optionally, at least one carbon or hydrogen in the alkyl carbon chain is substituted by oxygen or halogen.

Optionally, the structural formula of the thiophene compound is any one of following:

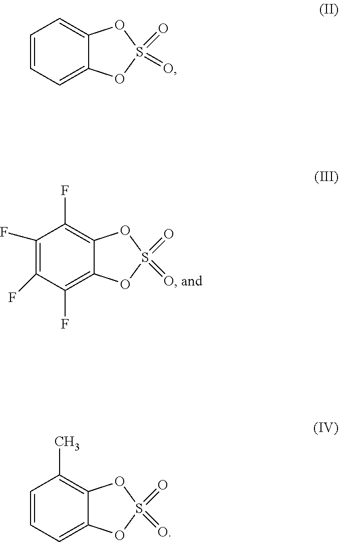

Optionally, the electrolyte salt includes at least one of lithium bis(trifluoromethanesulphonyl)imide, lithium bis(fluorosulfonyl)imide, or lithium hexafluorophosphate.

According to a second aspect, an embodiment of the present disclosure provides a preparation method of a battery electrolyte solution. The method is used for preparing the battery electrolyte solution according to the first aspect. A percentage of each of the ethyl group solvent, the 1,3-propane sultone, and the nitrile substance in the battery electrolyte solution in the total mass of the electrolyte solution is determined based on a peeling strength expected to be reached after the positive electrode plate is infiltrated with the electrolyte solution, such that the percentages of the ethyl group solvent, the 1,3-propane sultone, and the nitrile substance in the total mass of the electrolyte solution meet: 0.45−N³≤A+B²+C²≤516−N³,

where N denotes a peeling strength value of the positive electrode plate, in a unit of gf/mm, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution.

According to a third aspect, an embodiment of the present disclosure provides a battery. The battery includes a positive electrode plate, a negative electrode plate, and the battery electrolyte solution according to the first aspect. Both the positive electrode plate and the negative electrode plate are infiltrated with the battery electrolyte solution, and the battery meets the following expression:

$$0.45 - {N}^{3} \leq A + {B}^{2} + {C}^{2} \leq 516 - {N}^{3} ,$$

where N denotes a peeling strength value of the positive electrode plate, in a unit of gf/mm, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution.

In embodiments of the present disclosure, the battery electrolyte solution is enabled to include an organic solvent, an additive, and an electrolyte salt. The organic solvent includes an ethyl group solvent, and the additive includes 1,3-propane sultone and a nitrile substance. Percentages of the ethyl group solvent, the 1,3-propane sultone, and the nitrile substance in a total mass of the electrolyte solution are configured as follows: 0.45−N³≤A+B²+C²≤516−N³, where N denotes a peeling strength value of the positive electrode plate, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution. A relatively robust composite solid electrolyte interface (Cathode Electrolyte Interphase, CEI) film can be formed on a surface of the positive electrode plate while improving infiltration of the positive electrode plate. In this way, a side reaction between a positive electrode active material and the electrolyte solution is reduced, which further reduces accumulation of a side reaction product, thereby increasing a peeling strength of the positive electrode plate, and reducing an internal resistance of the battery. In this way, safety accidents due to a continuous increase in a temperature of the battery can be avoided. In addition, an impedance of a CEI film formed by the 1,3-propane sultone and the nitrile substance on the positive electrode plate is relatively low, which may increase a migration rate of lithium ions, thereby efficiently protecting the positive electrode active material, and inhibiting dissolution of metal ions and catalyzing decomposition of the side reaction product. In this way, metal ions can be prevented from depositing on the surface of the negative electrode plate, thereby avoiding safety accidents, and further reducing an internal resistance of the battery. In other words, the battery electrolyte solution provided in the present disclosure can improve high-temperature performance and safety performance of the battery, and does not lead to degradation of other performance of the battery, thereby providing a guarantee for low-temperature performance and long-cycling performance of the battery.

### BRIEF DESCRIPTION OF THE DRAWINGS

To describe the technical solutions in the embodiments of the present disclosure more clearly, the accompanying drawing in this specification is described below. Apparently, the following accompanying drawing is merely an embodiment of the present disclosure, and a person of ordinary skill in the art may still derive other drawings from the listed accompanying drawing without creative efforts.

FIG. 1 is a schematic structural diagram of a battery according to an embodiment of the present disclosure.

### DETAILED DESCRIPTION OF THE EMBODIMENTS

The following clearly describes the technical solutions in embodiments of the present disclosure with reference to the accompanying drawings in embodiments of the present disclosure. Apparently, the described embodiments are merely some but not all of embodiments of the present disclosure. All other embodiments obtained by a person of ordinary skill in the art based on the embodiments of the present disclosure without creative efforts shall fall within the protection scope of the present disclosure.

An embodiment of the present disclosure provides a battery electrolyte solution. The battery electrolyte solution includes an organic solvent, an additive, and an electrolyte salt. The organic solvent includes an ethyl group solvent, and the additive includes 1,3-propane sultone and a nitrile substance. The electrolyte solution is in contact with a positive electrode plate. Percentages of the ethyl group solvent, the 1,3-propane sultone, and the nitrile substance in a total mass of the electrolyte solution are configured as follows:

$$0.45 - {N}^{3} \leq A + {B}^{2} + {C}^{2} \leq 516 - {N}^{3} ,$$

where N denotes a peeling strength value of the positive electrode plate, in a unit of gf/mm, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution.

In the present disclosure, the battery electrolyte solution is a non-aqueous electrolyte solution

It should be understood that N is a peeling strength value of the positive electrode plate, in a unit of gf/mm. The peeling strength value N can be set according to an actual situation, for example, N can be 1 gf/mm, 1.2 gf/mm, 0.1 gf/mm, 1.5 gf/mm, 3.6 gf/mm, 8 gf/mm, 10 gf/mm, or 15 gf/mm, or can be a range composed of any two of these values. A peeling strength of the positive electrode plate refers to a maximum force required to peel off a positive electrode active material layer per unit width, and is used to reflect a bonding strength between the positive electrode active material layer and a current collector. A method for testing a peeling force strength includes: cutting each positive electrode plate into a sample strip of 24 mm×15 cm, covering the strip with a glass slide, pressing the electrode plate back and forth by using a roller, and testing the strip with a tensile machine at a speed of 200 mm/min, to obtain a testing result that is a peel force of P (in a unit of gf). A calculation formula is as follows: Peeling strength N (gf/mm)=P/24 mm (width).

In a relational expression of the present disclosure, only a numerical portion of the peeling strength value rather than a unit portion participates in calculation. The foregoing relational expression is used as an example. For example, in Example 1 of the present disclosure, if the percentage A of the mass of the ethyl group solvent in the total mass of the electrolyte solution is 55% (0.55), the percentage B of the mass of the 1,3-propane sultone in the total mass of the electrolyte solution is 5% (0.05), the percentage C of the mass of the nitrile substance in the total mass of the electrolyte solution is 5% (0.05), and the peeling strength value is 1 gf/mm, N³+A+B²+C²=1³+0.55+0.05²+0.05²=1.555 (which is 1.56 after being rounded to two decimal places).

In embodiments of the present disclosure, the electrolyte solution is enabled to include an organic solvent, an additive, and an electrolyte salt, the organic solvent includes an ethyl group solvent, the additive includes 1,3-propane sultone and a nitrile substance, and the ethyl group solvent may cause a synergistic effect between the positive electrode plate and the electrolyte solution, so that low-temperature performance, high-temperature performance, and safety performance of the battery can be effectively improved. In other words, a problem of how to improve safety performance of a battery while avoiding degradation of other performance of the battery is resolved.

Further, a value of A+B²+C²+N³ can be 0.45, 10, 15, 22, 100, 156, 200, 221, 300, 321, 389, 400, 450, 500, 516, or the like, or can be any value within a range composed of any two of these values. When the value of A+B²+C²+N³ ranges from 0.45 to 516 (including endpoints), a better synergistic effect is achieved between the positive electrode plate and the electrolyte solution.

In embodiments of the present disclosure, the battery electrolyte solution is enabled to include an organic solvent, an additive, and an electrolyte salt. The organic solvent includes an ethyl group solvent, and the additive includes 1,3-propane sultone and a nitrile substance. Percentages of the ethyl group solvent, the 1,3-propane sultone, and the nitrile substance in a total mass of the electrolyte solution are configured as follows: 0.45−N³≤A+B²+C²≤516−N³, where N denotes a peeling strength value of the positive electrode plate, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution. A relatively robust composite solid electrolyte interface (Cathode Electrolyte Interphase, CEI) film can be formed on a surface of the positive electrode plate while improving infiltration of the positive electrode plate. In this way, a side reaction between a positive electrode active material and the electrolyte solution is reduced, which further reduces accumulation of a side reaction product between the positive electrode active material and a current collector and on the surface of the positive electrode plate, thereby increasing a peeling strength of the positive electrode plate, and reducing an internal resistance of the battery. In this way, safety accidents due to a continuous increase in a temperature of the battery can be avoided. In addition, an impedance of a CEI film formed by the 1,3-propane sultone and the nitrile substance on the positive electrode plate is relatively low, which may increase a migration rate of lithium ions, thereby efficiently protecting the positive electrode active material, and inhibiting dissolution of metal ions and catalyzing decomposition of the side reaction product. In this way, metal ions can be prevented from depositing on the surface of the negative electrode plate, thereby avoiding safety accidents, and further reducing an internal resistance of the battery. In other words, the battery electrolyte solution provided in the present disclosure can improve high-temperature performance and safety performance of the battery, and does not lead to degradation of other performance of the battery, thereby providing a guarantee for low-temperature performance and long-cycling performance of the battery.

In an example, the peeling strength value N of the positive electrode plate ranges from 0.2 gf/mm to 8 gf/mm.

In an example, the mass of the ethyl group solvent accounts for 40 wt % to 85 wt % of the total mass of the electrolyte solution.

Optionally, the ethyl group solvent includes at least one of ethyl methyl carbonate, diethyl carbonate, methyl propyl carbonate, ethyl propionate, propyl propionate, ethyl acetate, or ethyl butyrate.

Optionally, the ethyl group solvent includes at least one of ethyl methyl carbonate, diethyl carbonate, methyl propyl carbonate, ethyl propionate, or propyl propionate.

In an example, the mass of the 1,3-propane sultone accounts for 0.5 wt % to 8 wt % of the total mass of the electrolyte solution.

In an example, the mass of the nitrile substance accounts for 2 wt % to 8 wt % of the total mass of the electrolyte solution.

During specific implementation, the peeling strength N of the positive electrode plate can be 0.2 gf/mm, 0.5 gf/mm, 0.8 gf/mm, 1 gf/mm, 1.1 gf/mm, 1.3 gf/mm, 1.5 gf/mm, 1.8 gf/mm, 2 gf/mm, 3 gf/mm, 3.6 gf/mm, 4 gf/mm, 4.5 gf/mm, 5 gf/mm, 6 gf/mm, 7 gf/mm, 8 gf/mm, or the like, or can be any value within a range composed of any two of these values. When the peeling strength value N of the positive electrode plate ranges from 0.2 gf/mm to 8 gf/mm, a better synergistic effect can be achieved between the positive electrode plate and the electrolyte solution, thereby further improving safety performance of the battery while avoiding degradation of other performance of the battery.

The mass of the ethyl group solvent may account for 40 wt %, 50 wt %, 54 wt %, 60 wt %, 68 wt %, 70 wt %, 71 wt %, 80 wt %, 85 wt %, or the like of the total mass of the electrolyte solution, or can be any value within a range composed of any two of these values. When the mass of the ethyl group solvent accounts for 40 wt % to 85 wt % of the total mass of the electrolyte solution, a better synergistic effect can be achieved between the positive electrode plate and the electrolyte solution, thereby further improving safety performance of the battery while avoiding degradation of other performance of the battery.

The mass of the 1,3-propane sultone may account for 0.5 wt %, 1 wt %, 2 wt %, 3 wt %, 4 wt %, 5 wt %, 6 wt %, 7 wt %, 8 wt %, or the like of the total mass of the electrolyte solution, or can be any value within a range composed of any two of these values. When the mass of the 1,3-propane sultone accounts for 0.5 wt % to 8 wt % of the total mass of the electrolyte solution, a better synergistic effect can be achieved between the positive electrode plate and the electrolyte solution, thereby further improving safety performance of the battery while avoiding degradation of other performance of the battery.

The mass of the nitrile substance may account for 2 wt %, 3 wt %, 4 wt %, 5 wt %, 6 wt %, 7 wt %, 8 wt %, or the like of the total mass of the electrolyte solution, or can be any value within a range composed of any two of these values. When the mass of the nitrile substance accounts for 2 wt % to 8 wt % of the total mass of the electrolyte solution, a better synergistic effect can be achieved between the positive electrode plate and the electrolyte solution, thereby further improving safety performance of the battery while avoiding degradation of other performance of the battery.

When the peeling strength of the positive electrode plate, the mass of the ethyl group solvent, the mass of the 1,3-propane sultone, and the mass of the nitrile substance all meet the foregoing value range, a better synergistic effect can be achieved between the positive electrode plate and the electrolyte solution, compared to a case in which one/two/three of the peeling strength of the positive electrode plate, the mass of the ethyl group solvent, the mass of the 1,3-propane sultone, and the mass of the nitrile substance meets (one of them meets, two of them meets, or three of them meets) the foregoing value range.

In an embodiment, the nitrile substance is selected from at least one of a dinitrile compound represented by Formula A or a trinitrile compound represented by Formula B:

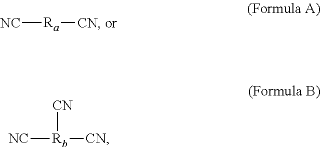

where Rₐ and R_{b} are each independently selected from substituted or unsubstituted C1-C10 alkylidene group, substituted or unsubstituted C2-C10 alkenylene group, substituted or unsubstituted C2-C10 alkynylene group; and if substituted, a substituent is halogen, C1-C10 alkyl, halogenated C1-C10 alkyl, C2-C10 alkenyl group, halogenated C2-C10 alkenyl group, C2-C10 alkynyl group, halogenated C2-C10 alkynyl group, C3-C10 cycloalkylidene group, or halogenated C3-C10 cycloalkylidene group.

Optionally, the nitrile substance includes at least one of succinonitrile, glutaronitrile, adiponitrile, pimelonitrile, suberonitrile, glycerol trinitrile, ethoxy(pentafluoro)phosphazene, or 1,3,6-hexanetricarbonitrile. For example, the nitrile substance can be glutaronitrile, or can be adiponitrile, pimelonitrile, or suberonitrile.

Optionally, the additive further includes a thiophene compound, and a structural formula of the thiophene compound is as follows:

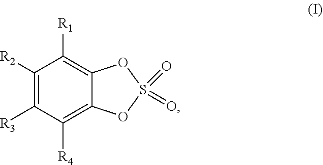

where R₁ is any one of hydrogen, halogen, and an alkyl carbon chain, R₂ is any one of hydrogen, halogen, and an alkyl carbon chain, R₃ is any one of hydrogen, halogen, and an alkyl carbon chain, R₄ is any one of hydrogen, halogen, and an alkyl carbon chain, and a quantity of carbon atoms in the alkyl carbon chain ranges from 1 to 10.

During specific implementation, R₁, R₂, R₃, and R₄ can be completely identical, can be partially identical, or can be completely different from one another. A quantity of carbon atoms in the alkyl carbon chain can be 1, 2, 3, 4, 5, 6, 7, 8, 9, or 10.

Enabling the additive to include the thiophene compound may cause the thiophene compound to undergo polymerization reaction on the surfaces of both the positive electrode plate and the negative electrode plate, so as to form a network-like passivation film. The formed passivation film has a relatively small impedance, and may cover the surface of the positive electrode active material, thereby effectively preventing a side reaction, on the surface of the positive electrode, caused by oxygen release from the positive electrode active material. Since the side reaction may produce a side reaction product that increases an impedance, preventing a side reaction of the positive electrode active material can reduce an increase in an impedance of the battery during a cycling process, thereby improving cycling performance of the battery, achieving a better synergistic effect between the positive electrode plate and the electrolyte solution, and further improving low-temperature performance, high-temperature performance, and safety performance of the battery.

Optionally, the halogen is any one of fluorine, chlorine, and bromine. For example, R₁ is fluorine, R₂ is bromine, R₃ is hydrogen, and R₄ is an alkyl carbon chain.

Optionally, at least one carbon or hydrogen in the alkyl carbon chain is substituted by oxygen or halogen.

During specific implementation, at least one carbon in the alkyl carbon chain can be substituted by oxygen or halogen, or at least one hydrogen in the alkyl carbon chain can be substituted by oxygen or halogen, or at least one carbon and at least one hydrogen in the alkyl carbon chain can be substituted by oxygen or halogen.

Optionally, a structural formula of the thiophene compound is any one of following:

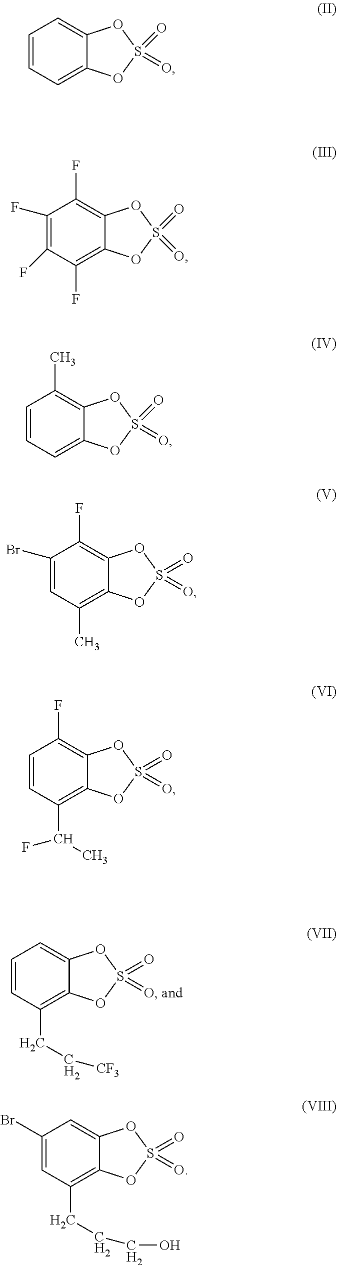

When the structural formula of the thiophene compound is any one of the foregoing structural formulas, the thiophene compound may form a denser and lower-impedance network-like passivation film on the surfaces of the positive and negative electrode plates. Therefore, cycling performance of the battery is further improved, so that a better synergistic effect is achieved between the positive electrode plate and the electrolyte solution, thereby further improving low-temperature performance, high-temperature performance, and safety performance of the battery.

Optionally, the electrolyte salt includes at least one of lithium bis(trifluoromethanesulphonyl)imide, lithium bis(fluorosulfonyl)imide, lithium hexafluorophosphate, lithium difluorophosphate, lithium bisoxalate borate, lithium difluoro(oxalato)borate, lithium difluoro oxalate phosphate, lithium tetrafluoroborate, or lithium tetrafluoro(oxalato)phosphate.

Optionally, the electrolyte salt includes at least one of lithium bis(trifluoromethanesulphonyl)imide, lithium bis(fluorosulfonyl)imide, or lithium hexafluorophosphate.

Optionally, the mass of the electrolyte salt accounts for 12 wt % to 20 wt % of the total mass of the electrolyte solution.

Optionally, the additive may further include another additive different from the 1,3-propane sultone and the nitrile substance. The another additive may include at least one of a sulfur-containing compound or a carbonate compound. The sulfur-containing compound is selected from one or more of 1-propene 1,3-sultone, ethylene sulfate, and vinylene sulfate. The carbonate compound is one or more of ethylene carbonate, fluoroethylene carbonate, and vinyl ethylene carbonate. A total mass of the another additive accounts for 0 wt % to 10 wt % of a total mass of a electrolyte solution, and can be specifically 0 wt %, 1 wt %, 2 wt %, 3 wt %, 4 wt %, 5 wt %, 6 wt %, 7 wt %, 8 wt %, 9 wt %, 10 wt %, or the like, or can be any value within a range composed of any two of these values.

Optionally, the organic solvent may further include at least one of carbonate, carboxylic acid ester, or fluorinated ether. The carbonate is selected from one or more of ethylene carbonate, propylene carbonate, fluoroethylene carbonate, dimethyl carbonate, ethyl methyl carbonate, diethyl carbonate, and methyl propyl carbonate. The carboxylic acid ester is selected from one or more of ethyl propionate or propyl propionate. The fluorinated ether can be 1,1,2,2-tetrafluoroethyl-2,2,3,3-tetrafluoropropyl ether.

An embodiment of the present disclosure further provides a preparation method of a battery electrolyte solution. The method is used for preparing the battery electrolyte solution provided in embodiments of the present disclosure. A percentage of each of the ethyl group solvent, the 1,3-propane sultone, and the nitrile substance in the battery electrolyte solution in the total mass of the electrolyte solution is determined based on a peeling strength expected to be reached after the positive electrode plate is infiltrated with the electrolyte solution, such that the percentages of the ethyl group solvent, the 1,3-propane sultone, and the nitrile substance in the total mass of the electrolyte solution meet: 0.45−N³≤A+B²+C²≤516−N³,

where N denotes a peeling strength value of the positive electrode plate, in a unit of gf/mm, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution.

In embodiments of the present disclosure, specific values of A, B, and C are determined based on the preset peeling strength value of the positive electrode plate and 0.45−N³≤A+B²+C²≤516−N³, so that a relatively robust composite solid electrolyte interface (Cathode Electrolyte Interphase, CEI) film can be formed on a surface of the positive electrode plate while improving infiltration of the positive electrode plate. In this way, a side reaction between a positive electrode active material and the electrolyte solution is reduced, which further reduces accumulation of a side reaction product, thereby increasing a peeling strength of the positive electrode plate, and reducing an internal resistance of the battery. In this way, safety accidents due to a continuous increase in a temperature of the battery can be avoided. In addition, an impedance of a CEI film formed by the 1,3-propane sultone and the nitrile substance on the positive electrode plate is relatively low, which may increase a migration rate of lithium ions, thereby efficiently protecting the positive electrode active material, and inhibiting dissolution of metal ions and catalyzing decomposition of the side reaction product. In this way, metal ions can be prevented from depositing on the surface of the negative electrode plate, thereby avoiding safety accidents, and further reducing an internal resistance of the battery. In other words, the battery electrolyte solution provided in the present disclosure may improve high-temperature performance and safety performance of the battery, and does not lead to degradation of other performance of the battery, thereby providing a guarantee for low-temperature performance and long-cycling performance of the battery.

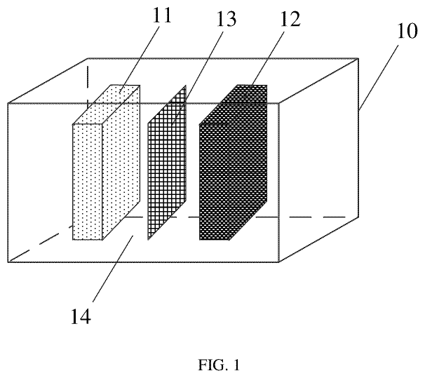

Referring to FIG. 1, an embodiment of the present disclosure further provides a battery 10. The battery includes a positive electrode plate 12, a negative electrode plate 11, and the battery electrolyte solution 14 provided in the embodiments of the present disclosure, both the positive electrode plate 12 and the negative electrode plate 11 are infiltrated with the battery electrolyte solution 14, and the battery 10 meets the following expression:

$$0.45 - {N}^{3} \leq A + {B}^{2} + {C}^{2} \leq 516 - {N}^{3} ,$$

where N denotes a peeling strength value of the positive electrode plate 12 that is obtained by disassembling the battery 10, A denotes a percentage of a mass of the ethyl group solvent in the total mass of the electrolyte solution 14, B denotes a percentage of a mass of the 1,3-propane sultone in the total mass of the electrolyte solution 14, and C denotes a percentage of a mass of the nitrile substance in the total mass of the electrolyte solution 14.

It should be understood that a peeling strength value expected to be reached after the positive electrode plate 12 is infiltrated with the electrolyte solution 14 is generally equal to a peeling strength (that is, the peeling strength of the positive electrode plate 12 that is obtained by dismantling the battery 10) after the positive electrode plate 12 is infiltrated with the electrolyte solution 14.

During specific implementation, the battery 10 can be a wound battery, or can be a stacked battery, and the battery 10 further includes a separator 13 disposed between the positive electrode plate 12 and the negative electrode plate 11. The negative electrode plate 11, the separator 13, and the positive electrode plate 12 are sequentially stacked, and the positive electrode plate 12, the negative electrode plate 11, and the separator 13 are all infiltrated with the electrolyte solution 14. When the battery 10 is a stacked battery, a structure of the battery is shown in FIG. 1.

The positive electrode plate 12 includes a positive electrode current collector, and a positive electrode active material layer is applied on one or both sides of the positive electrode current collector. The positive electrode active material layer includes a positive electrode active material, a conductive agent, and a binder.

The positive electrode active material is selected from lithium cobaltate or lithium cobaltate doped and coated with two or more elements in Al, Mg, Mn, Cr, Ti, or Zr. A chemical formula of the lithium cobaltate doped and coated with two or more elements in Al, Mg, Mn, Cr, Ti, or Zr is LiₓGo_{1-y1-y2-y3-y4}E_{y1}F_{y2}G_{y3}D_{y4}O₂, where 0.95≤x≤1.05, 0.01≤y1≤0.1, 0.01≤y2≤0.1, 0≤y3≤0.1, 0≤y4≤0.1, and E, F, G, and D are selected from two or more elements in Al, Mg, Mn, Cr, Ti, or Zr.

The negative electrode plate 11 includes a negative electrode current collector, and a negative electrode active material layer is applied on one or both sides of the negative electrode current collector. The negative electrode active material layer includes a negative electrode active material, a conductive agent, and a binder.

Optionally, the negative electrode active material is graphite.

Optionally, the negative electrode active material includes graphite, and the negative electrode active material further includes at least one of SiOₓ or Si, where 0<x<2.

A charge cut-off voltage of the battery provided in this embodiment of the present disclosure is 4.48 V or above.

For a structure and a working principle of the electrolyte solution provided in this embodiment of the present disclosure, reference can be made to the foregoing embodiment, and details are not described herein again. The battery provided in this embodiment of the present disclosure includes the electrolyte solution provided in the embodiments of the present disclosure. Therefore, the battery provided in this embodiment of the present disclosure has all beneficial effects of the electrolyte solution provided in the embodiments of the present disclosure.

The following describes, with specific experiments, the battery provided in this embodiment of the present disclosure.

### Comparative Examples 1 to 5 and Examples 1 to 9

Lithium-ion batteries in Comparative Examples 1 to 5 and Examples 1 to 9 were prepared according to the following preparation method, and a difference lies only in peeling strengths of positive electrode plates and electrolyte solutions. The difference in the peeling strengths of positive electrode plates and the electrolyte solutions is specifically shown in Table 1.

### (1) Preparation of a Positive Electrode Plate

A positive electrode active material LiCoO₂ with a mass percentage of 97.5%, a binder polyvinylidene fluoride (PVDF) with a mass percentage of 1.3%, and a conductive agent acetylene black with a mass percentage of 1.2% were mixed, and were added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 12 μm. The coated aluminum foil was baked in a five-stage oven with different temperatures and then dried in an oven at 120° C. for eight hours, followed by rolling and cutting, to obtain required different positive electrode plates with peeling strength values expected to be reached (specific peeling strength values are shown in Table 1).

### (2) Preparation of a Negative Electrode Plate

A negative electrode active material artificial graphite with a mass percentage of 96.5%, a conductive agent single-walled carbon nanotube (SWCNT) with a mass percentage of 0.2%, a conductive agent conductive carbon black (SP) with a mass percentage of 1%, a binder sodium carboxymethyl cellulose (CMC) with a mass percentage of 1%, and a binder styrene-butadiene rubber (SBR) with a mass percentage of 1.3% were made into a slurry by using a wet process. The slurry was applied on a surface of a negative electrode current collector made of copper foil, and then drying (temperature: 85° C., time: 5 h), rolling, and die cutting were carried out to obtain required negative electrode plates.

### (3) Preparation of an Electrolyte Solution

In a glove box filled with argon (moisture<10 ppm, oxygen<1 ppm), ethylene carbonate (EC) and propylene carbonate (PC) were evenly mixed at a mass ratio of 2:1, an ethyl group solvent accounting for 40 wt % to 85 wt % of a total mass of a non-aqueous electrolyte solution (specific percentages and types of the ethyl group solvent are shown in Table 1), and LiPF₆ accounting for 14 wt % of the total mass of the non-aqueous electrolyte solution and an additive (specific percentages and types of additives are shown in Table 1) were slowly added into the mixed solution. The mixture was stirred evenly to obtain the non-aqueous electrolyte solution.

### (4) Preparation of a Separator

A polyethylene separator with a thickness ranging from 7 μm to 9 μm is selected.

### (5) Preparation of a Lithium-Ion Battery

The foregoing prepared positive electrode plate, separator, and negative electrode plate were wound to obtain an unfilled bare cell. The bare cell was placed in outer packaging foil, the prepared electrolyte solution was injected into the dried bare cell, and after processes such as vacuum packaging, standing, formation, shaping, and sorting, the lithium-ion battery required was obtained.

TABLE 1

| | Total | | Total | | | | | | |
|---|---|---|---|---|---|---|---|---|---|
| | percentage | | percentage | Total | | | | Thiophene | |
| | A of the | | B 1,3- | percentage | | Peeling | | compound | |
| | ethyl group | Type of the | propane | C of | | strength N | N³ + A + | | Content/ |
| Item | solvent | ethyl group | sultone | nitriles | Types of Nitriles | (gf/mm) | B² + C² | Type | wt % |
| Comparative | 15% | propyl | 5% | 5% | 2% adiponitrile + | 1 | 1.16 | / | / |
| Example 1 | | propionate | | | 3% 1,3,6- | | | | |
| | | | | | hexanetricarbonitrile | | | | |
| Comparative | 55% | propyl | 0% | 5% | 2% adiponitrile + | 1 | 1.55 | / | / |
| Example 2 | | propionate | | | 3% 1,3,6- | | | | |
| | | | | | hexanetricarbonitrile | | | | |
| Comparative | 55% | propyl | 5% | 0.0% | / | 1 | 1.55 | / | / |
| Example 3 | | propionate | | | | | | | |
| Comparative | 55% | propyl | 5% | 5% | 2% adiponitrile + | 10 | 1000.56 | / | / |
| Example 4 | | propionate | | | 3% 1,3,6- | | | | |
| | | | | | hexanetricarbonitrile | | | | |
| Comparative | 55% | propyl | 5% | 5% | 2% adiponitrile + | 0.1 | 0.56 | / | / |
| Example 5 | | propionate | | | 3% 1,3,6- | | | | |
| | | | | | hexanetricarbonitrile | | | | |
| Example 1 | 55% | propyl | 5% | 5% | 2% adiponitrile + | 1 | 1.56 | / | / |
| | | propionate | | | 3% 1,3,6- | | | | |
| | | | | | hexanetricarbonitrile | | | | |
| Example 2 | 60% | 40% propyl | 3% | 6% | 1% succinonitrile + | 0.8 | 1.12 | / | / |
| | | propionate + | | | 2% adiponitrile + | | | | |
| | | 20% ethyl | | | 3% 1,3,6- | | | | |
| | | propionate | | | hexanetricarbonitrile | | | | |
| Example 3 | 50% | 15% propyl | 4% | 4% | 1% succinonitrile + | 1.5 | 3.88 | / | / |
| | | propionate + | | | 2% adiponitrile + | | | | |
| | | 35% ethyl | | | 1% 1,3,6- | | | | |
| | | propionate | | | hexanetricarbonitrile | | | | |
| Example 4 | 40% | 20% propyl | 0.5% | 5% | 1% succinonitrile + | 3.6 | 47.06 | / | / |
| | | propionate + | | | 1% adiponitrile + | | | | |
| | | 15% ethyl | | | 3% 1,3,6- | | | | |
| | | propionate + | | | hexanetricarbonitrile | | | | |
| | | 5% diethyl | | | | | | | |
| | | carbonate | | | | | | | |
| Example 5 | 45% | 20% propyl | 4% | 3.5% | 1% succinonitrile + | 0.2 | 0.46 | II | 0.1% |
| | | propionate + | | | 2.5% glycerol | | | | |
| | | 10% ethyl | | | trinitrile | | | | |
| | | propionate + | | | | | | | |
| | | 15% ethyl | | | | | | | |
| | | methyl | | | | | | | |
| | | carbonate | | | | | | | |
| Example 6 | 70% | 40% propyl | 6% | 2% | 1% succinonitrile + | 8 | 512.70 | III | 1% |
| | | propionate + | | | 1% glycerol | | | | |
| | | 25% ethyl | | | trinitrile | | | | |
| | | propionate + | | | | | | | |
| | | 5% diethyl | | | | | | | |
| | | carbonate | | | | | | | |
| Example 7 | 85% | 50% propyl | 8% | 5.5% | 1.5% succinonitrile + | 2 | 8.86 | IV | 0.3% |
| | | propionate + | | | 1% adiponitrile + | | | | |
| | | 20% diethyl | | | 3% 1,3,6- | | | | |
| | | carbonate + | | | hexanetricarbonitrile | | | | |
| | | 15% ethyl | | | | | | | |
| | | methyl | | | | | | | |
| | | carbonate | | | | | | | |
| Example 8 | 75% | 50% propyl | 4.5% | 8% | 1.5% succinonitrile + | 0.6 | 0.97 | II | 2.0% |
| | | propionate + | | | 1.5% ethoxy(penta- | | | | |
| | | 25% diethyl | | | fluoro)phosphazene + | | | | |
| | | carbonate | | | 2% adiponitrile + | | | | |
| | | | | | 3% 1,3,6- | | | | |
| | | | | | hexanetricarbonitrile | | | | |
| Example 9 | 55% | 35% propyl | 5% | 5% | 2% adiponitrile + | 1 | 1.56 | III | 0.5% |
| | | propionate + | | | 3% 1,3,6- | | | | |
| | | 20% diethyl | | | hexanetricarbonitrile | | | | |
| | | carbonate | | | | | | | |

A structural formula of the thiophene compound is any one of following:

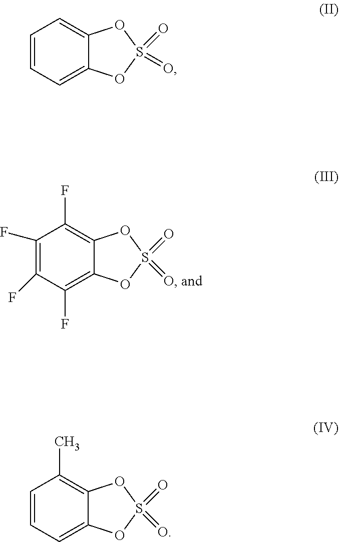

The batteries in Comparative Examples 1 to 5 and Examples 1 to 9 were tested for electrochemical performance. The related descriptions are as follows:

Peeling force strength test: Each of the positive electrode plates in the Examples and the Comparative Examples is cut into a sample strip of 24 mm×15 cm, covered with a glass slide, pressed back and forth by using a roller, and then tested with a tensile machine at a speed of 200 mm/min, to obtain a testing result that is a peel force of P (in a unit of gf).

A calculation formula used is as follows: Peeling strength N (gf/mm)=P/24 mm (width).

(1) 25° C. cycling test: The batteries obtained in the Examples and Comparative Examples were placed in an environment of (25±2° C.) to stand for two to three hours. When the battery bodies reached (25±2)° C., the batteries were charged at a constant current of 1.1C, with a cut-off current of 0.05C. After the batteries were fully charged, the batteries were left aside for five minutes, and then discharged at a constant current of 0.5C to a cut-off voltage of 3.0 V. A highest discharge capacity for the first three cycles was recorded as an initial capacity Q. When the number of cycles reaches 1000, the last discharge capacity of the battery was recorded as Q1. Recorded results are shown in Table 2.

A calculation formula used is as follows: Capacity retention rate (%)=Q1/Q×100%.

(2) 85° C. and 8-hour high-temperature storage test: The batteries obtained in the Examples and Comparative Examples were charged and discharged three times at a charge and discharge rate of 0.5C at room temperature, and then charged to a fully charged state at a rate of 0.5C. A highest discharge capacity Q2 of the first three cycles at 0.5C was recorded. The batteries in a fully charged state were stored at 85° C. for eight hours. After eight hours, a 0.5C discharge capacity Q3 for each battery was recorded. Then, experimental data such as a capacity retention rate and whether gas is generated that are stored at a high temperature of each battery were obtained by calculation. Recorded results are shown in Table 2.

A calculation formula used is as follows: Capacity retention rate (%)=Q3/Q2×100%.

(3) In a nail penetration test, a high-temperature resistant steel needle (a cone angle of the needle tip ranges from 45° to 60°, and a surface of the needle is smooth without rust, oxide layer, or grease) with a diameter of ϕ ranging from 5 mm to 8 mm penetrated through the batteries obtained in Examples 1 to 9 and Comparative Examples 1 to 5 from a direction perpendicular to electrode plates of the batteries at a speed of (25±5) mm/s, and a penetration position was preferably close to a geometric center of a penetrated surface (the steel needle remained in the batteries). Based on observation, after one hour or when a maximum temperature of surfaces of the batteries dropped to 10° C. or below, the test ended.

(4) Low-temperature discharge test: The batteries obtained in the Examples and Comparative Examples were first discharged at 0.2C to 3.0 V at an ambient temperature of (25±3° C.), and left aside for five minutes. The batteries were charged at 0.7C, and when a voltage across cell terminals reached a charging limit voltage, the batteries began to be charged at a constant voltage. The charging was not stopped until a charging current is less than or equal to a cut-off current. The batteries were left aside for five minutes and then discharged at 0.2C to 3.0 V, and a discharge capacity in this case was recorded as a normal-temperature capacity Q4. Then, the cells were charged at 0.7C, and when a voltage across the cell terminals reached a charging limit voltage, the batteries began to be charged at a constant voltage. The charging was not stopped until a charging current is less than or equal to a cut-off current. The fully charged batteries were left aside at (−10±2° C.) for four hours, and then discharged at a current of 0.2C to a cut-off voltage of 3.0 V. A discharge capacity Q5 was recorded to calculate a low-temperature discharge capacity retention rate. Recorded results are shown in Table 2.

A calculation formula used is as follows: Low-temperature discharge capacity retention rate (%)=Q5/Q4×100%.

(5) 130° C. thermal shock test: The batteries obtained in the Examples and Comparative Examples were heated in a convection mode or by using a circulation hot air box at a start temperature of (25±3° C.), with a temperature change rate of (5±2° C.)/min. The temperature was raised to (130±2° C.), the batteries were kept in the temperature for 60 minutes, and state results of the batteries were recorded and are shown in Table 2.

TABLE 2

| | | | | | Safety test (Criteria for passing | |
|---|---|---|---|---|---|---|
| | Capacity | | | | this test are that neither fire nor | |
| | retention | | | Capacity | explosion occurs) | |
| | rate after | 85° C. high-temperature | | retention rate | Nail | 130° C. |
| | 1000 | storage for eight hours | | after | penetration | thermal shock |
| | cycles at | Capacity | | discharge | (number of | (number of |
| | 25° C. and | retention | Battery | at −10° C. and | passed/number | passed/number |
| Group | 1.1 C | rate (%) | state | 0.2 C | of tested) | of tested) |
| Comparative | 52.1% | 63.7% | Gassing | 63.1% | 1/5 | 1/5 |
| Example 1 | | | | | | |
| Comparative | 21.0% | 28.1% | Severe | 65.0% | 0/5 | 1/5 |
| Example 2 | | | gassing | | | |
| Comparative | 27.6% | 22.5% | Severe | 62.4% | 1/5 | 2/5 |
| Example 3 | | | gassing | | | |
| Comparative | 48.8% | 51.4% | Gassing | 62.8% | 1/5 | 2/5 |
| Example 4 | | | | | | |
| Comparative | 42.1% | 51.8% | Gassing | 65.8% | 0/5 | 1/5 |
| Example 5 | | | | | | |
| Example 1 | 66.1% | 71.1% | No gassing | 70.1% | 5/5 | 5/5 |
| Example 2 | 64.3% | 73.4% | No gassing | 78.3% | 5/5 | 5/5 |
| Example 3 | 68.4% | 70.4% | No gassing | 75.4% | 5/5 | 5/5 |
| Example 4 | 69.1% | 74.0% | No gassing | 76.1% | 5/5 | 5/5 |
| Example 5 | 73.0% | 79.4% | No gassing | 72.5% | 5/5 | 5/5 |
| Example 6 | 76.3% | 76.3% | No gassing | 73.3% | 5/5 | 5/5 |
| Example 7 | 74.2% | 78.1% | No gassing | 71.1% | 5/5 | 5/5 |
| Example 8 | 72.5% | 75.4% | No gassing | 74.3% | 5/5 | 5/5 |
| Example 9 | 73.1% | 74.8% | No gassing | 72.5% | 5/5 | 5/5 |

It can be learned from the experimental test results of the batteries in Comparative Examples 1 to 5 and Examples 1 to 9 in Table 2 that, through the synergistic effect between the positive electrode and the electrolyte solution of the lithium-ion battery, a better and relatively robust composite CEI film can be formed on the surface of the positive electrode plate while improving infiltration of the positive electrode when the value of N³+A+B²+C² ranges from 0.45 to 516. The CEI film may reduce a side reaction between the positive electrode active material and the electrolyte solution, and further reduce accumulation of a side reaction product, which may increase a peeling strength value of the positive electrode plate, and reduce an internal resistance of the battery. In addition, the CEI film efficiently protects the positive electrode active material, which may inhibit dissolution of metal ions, and may catalyze decomposition of the side reaction product of the electrolyte solution, thereby improving high-temperature storage and safety performance of the battery, and providing a guarantee for low-temperature performance and long-cycling performance of the battery.

The embodiments of the present disclosure are described above with reference to the accompanying drawings, but the present disclosure is not limited to the foregoing specific implementations. The foregoing specific implementations are merely illustrative and nonrestrictive. Under the guidance of the present disclosure, a person of ordinary skill in the art can also make many forms without departing from the scope of protection of the present disclosure and the claims, all of which are within the protection of the present disclosure.

What is claimed is:

1. A battery electrolyte solution, comprising an organic solvent, an additive, and an electrolyte salt, wherein the organic solvent comprises an ethyl group solvent, and the additive comprises 1,3-propane sultone and a nitrile substance; the electrolyte solution is in contact with a positive electrode plate; and percentages of the ethyl group solvent, the 1,3-propane sultone, and the nitrile substance in a total mass of the electrolyte solution are configured as follows:
$$0.45 - {N}^{3} \leq A + {B}^{2} + {C}^{2} \leq 516 - {N}^{3} ,$$
wherein N denotes a peeling strength value of the positive electrode plate, in a unit of gf/mm, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution.

2. The battery electrolyte solution according to claim 1, wherein the peeling strength value N of the positive electrode plate ranges from 0.2 gf/mm to 8 gf/mm.

3. The battery electrolyte solution according to claim 1, wherein the mass of the ethyl group solvent accounts for 40 wt % to 85 wt % of the total mass of the electrolyte solution.

4. The battery electrolyte solution according to claim 1, wherein the mass of the 1,3-propane sultone accounts for 0.5 wt % to 8 wt % of the total mass of the electrolyte solution.

5. The battery electrolyte solution according to claim 1, wherein the mass of the nitrile substance accounts for 2 wt % to 8 wt % of the total mass of the electrolyte solution.

6. The battery electrolyte solution according to claim 1, wherein the ethyl group solvent comprises at least one of ethyl methyl carbonate, diethyl carbonate, methyl propyl carbonate, ethyl propionate, propyl propionate, ethyl acetate, or ethyl butyrate.

7. The battery electrolyte solution according to claim 1, wherein the ethyl group solvent comprises at least one of ethyl methyl carbonate, diethyl carbonate, methyl propyl carbonate, ethyl propionate, or propyl propionate.

8. The battery electrolyte solution according to claim 1, wherein the nitrile substance is selected from at least one of a dinitrile compound represented by Formula A or a trinitrile compound represented by Formula B: 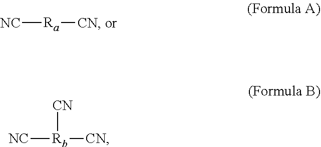
wherein Rₐ and R_{b} are each independently selected from substituted or unsubstituted C1-C10 alkylidene group, substituted or unsubstituted C2-C10 alkenylene group, substituted or unsubstituted C2-C10 alkynylene group; and if substituted, a substituent is halogen, C1-C10 alkyl, halogenated C1-C10 alkyl, C2-C10 alkenyl group, halogenated C2-C10 alkenyl group, C2-C10 alkynyl group, halogenated C2-C10 alkynyl group, C3-C10 cycloalkylidene group, or halogenated C3-C10 cycloalkylidene group.

9. The battery electrolyte solution according to claim 1, wherein the nitrile substance comprises at least one of following:
succinonitrile, glutaronitrile, adiponitrile, pimelonitrile, suberonitrile, glycerol trinitrile, ethoxy(pentafluoro)phosphazene, or 1,3,6-hexanetricarbonitrile.

10. The battery electrolyte solution according to claim 1, wherein the additive further comprises a thiophene compound, and a structural formula of the thiophene compound is as follows: 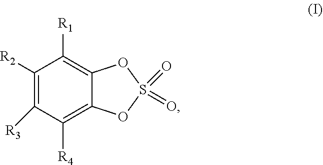
wherein R₁ is any one of hydrogen, halogen, and an alkyl carbon chain, R₂ is any one of hydrogen, halogen, and an alkyl carbon chain, R₃ is any one of hydrogen, halogen, and an alkyl carbon chain, R₄ is any one of hydrogen, halogen, and an alkyl carbon chain, and a quantity of carbon atoms in the alkyl carbon chain ranges from 1 to 10; the halogen is any one of fluorine, chlorine, and bromine.

11. The battery electrolyte solution according to claim 10, wherein at least one carbon or hydrogen in the alkyl carbon chain is substituted by oxygen or halogen.

12. The battery electrolyte solution according to claim 10, wherein a structural formula of the thiophene compound is any one of following:

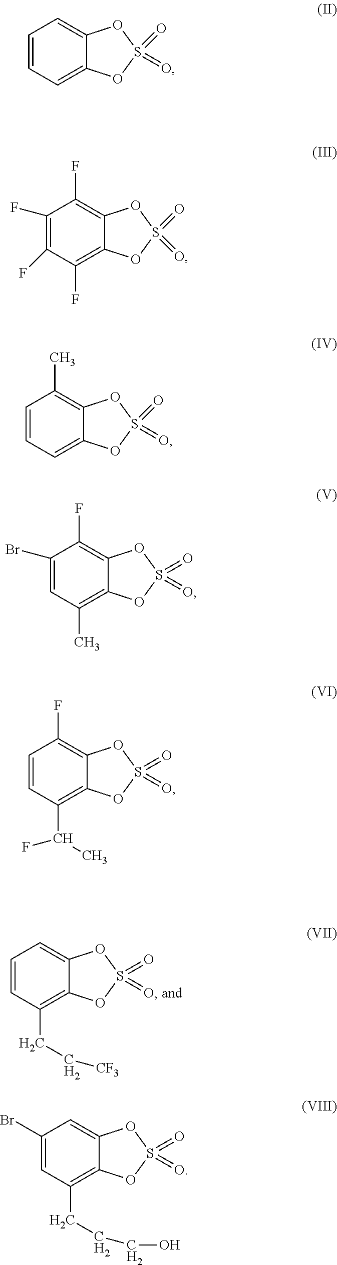

13. The battery electrolyte solution according to claim 1, wherein the electrolyte salt comprises at least one of lithium bis(trifluoromethanesulphonyl)imide, lithium bis(fluorosulfonyl)imide, lithium hexafluorophosphate, lithium difluorophosphate, lithium bisoxalate borate, lithium difluoro(oxalato)borate, lithium difluoro oxalate phosphate, lithium tetrafluoroborate, or lithium tetrafluoro(oxalato)phosphate.

14. The battery electrolyte solution according to claim 1, wherein the electrolyte salt comprises at least one of lithium bis(trifluoromethanesulphonyl)imide, lithium bis(fluorosulfonyl)imide, or lithium hexafluorophosphate.

15. The battery electrolyte solution according to claim 1, wherein a mass of the electrolyte salt accounts for 12 wt % to 20 wt % of the total mass of the electrolyte solution.

16. The battery electrolyte solution according to claim 1, wherein the additive further comprises at least one of a sulfur-containing compound or a carbonate compound.

17. The battery electrolyte solution according to claim 16, wherein the sulfur-containing compound is selected from one or more of 1-propene 1,3-sultone, ethylene sulfate, and vinylene sulfate; and/or
the carbonate compound is one or more of ethylene carbonate, fluoroethylene carbonate, and vinyl ethylene carbonate.

18. The battery electrolyte solution according to claim 16, wherein a total mass of the sulfur-containing compound and/or the carbonate compound accounts for 0 wt % to 10 wt % of the total mass of the electrolyte solution.

19. The battery electrolyte solution according to claim 1, wherein the organic solvent further comprises at least one of carbonate, carboxylic acid ester, or fluorinated ether.

20. A battery, comprising a positive electrode plate, a negative electrode plate, and the battery electrolyte solution according to claim 1, wherein both the positive electrode plate and the negative electrode plate are infiltrated with the battery electrolyte solution, and the battery meets the following expression:
$$0.45 - {N}^{3} \leq A + {B}^{2} + {C}^{2} \leq 516 - {N}^{3} ,$$
wherein N denotes a peeling strength value of the positive electrode plate, in a unit of gf/mm, A denotes a percentage of a mass of the ethyl group solvent in the total mass of the electrolyte solution, B denotes a percentage of a mass of the 1,3-propane sultone in the total mass of the electrolyte solution, and C denotes a percentage of a mass of the nitrile substance in the total mass of the electrolyte solution.
